(19) United States
(12) Patent Application Publication
(10) Pub. No.: US 2002/0091649 A1
(43) Pub. Date: Jul. 11, 2002

(54) System and method providing stored value payment in multiple level enterprise

(75) Inventors: Dinesh K. Anvekar, Piscataway, NJ (US); Bhaskarpillai Gopinath, Watchung, NJ (US); Rajiv Mangla, New Delhi (IN); Sridhar Sundaram, Highland Park, NJ (US)

Correspondence Address: MOSER, PATTERSON & SHERIDAN L.L.P., 595 SHREWSBURY AVE, FIRST FLOOR, SHREWSBURY, NJ, 07702, US

(73) Assignee: Level Z, L.L.C.

(21) Appl. No.: 09/758,971

(22) Filed: Jan. 11, 2001

(51) Int. Cl. G06F 17/60; H04K 1/00; H04L 9/00

(52) U.S. Cl. 705/72; 705/1

(57) ABSTRACT

A system, method and data structure for on-line settlement of amounts payable to different entities within a multiple level marketing enterprise proximate the time services and/or products are rendered. The invention provides that financial settlements be made substantially immediately among the MLM company, the up-line and down-line representatives and the customer. This is achieved by a method for settling the various financial transactions through stored values personal identification numbers (PINs).

### FIELD OF THE INVENTION

The present invention relates to the field of stored value commerce systems and, more particularly, to a stored value commerce system capable of providing payment settlements within a multiple level enterprise, such as a multilevel marketing system.

### BACKGROUND OF THE INVENTION

Multiple Level Marketing (MLM) or Network Marketing is a method of marketing products and services through independent sales representatives who refer customers to the MLM Company, recruit other sales representatives, and draw commissions from the sales of the customers or recruits. MLM companies pay a major part of their advertising and sales/marketing budgets in commissions, bonuses, and overrides to their “network” of independent representatives, for the referrals these representatives make to new consumers.

Typically, four or more generations (or levels) of representatives are paid by MLM companies from a percentage of the wholesale/retail purchase price of their product/service. Thus a hierarchical tree of representatives is formed. In such a tree of representatives, privileges or rights for marketing and recruiting other representatives flow down the hierarchy while commissions and other financial rewards flow up as a result of marketing activity by representatives lower in the hierarchy.

In existing MLM systems, a representative has to wait for a period of time, typically of the order of a few weeks, before he can receive the commissions and other payments due to him from the MLM organization with reference to a sale or referral that he has made.

### SUMMARY OF THE INVENTION

These and other limitations associated with the prior art are overcome by the present invention of a system, method and data structure for on-line settlement of amounts due to different entities within a multiple level marketing enterprise proximate the time services and/or products are rendered. The invention provides that financial settlements be made substantially instantly among the MLM company, the up-line and down-line representatives and the customer. This is achieved by a method for settling the various financial transactions through stored values personal identification numbers (PINs).

A multi-level marketing (MLM) settlement method according to an embodiment of the invention comprises the steps of providing, to a new selling representative in exchange for a first value, a stored value card having associated with it a stored value account of an initial value, a reference number and a first personal identification number (PIN); registering said new selling representative within said MLM system using said stored value card reference number; and crediting, to respective stored value accounts of selling representatives hierarchically superior to said new selling representative, respective apportioned commissions earned by the use of said stored value card, said stored value card account value being debited in response to said use and said credited commissions.

### BRIEF DESCRIPTION OF THE DRAWINGS

A more complete understanding of the present invention may be obtained from consideration of the following description in conjunction with the drawings in which:

FIG. 1 is a block diagram of a multiple level marketing (MLM) system;

FIG. 2 is a block diagram of an exemplary embodiment of a sales processing system suitable for use in the MLM system of FIG. 1;

FIG. 3 is a representation of an exemplary selling representative database used in accordance with the principles embodied in the present invention;

FIG. 4 is a representation of an exemplary customer database used in accordance with the principles embodied in the present invention;

FIG. 5A is a representation of an exemplary selling representative personal identification number (PIN) mapping table used in accordance with the principles embodied in the present invention;

FIG. 5B is a representation of an exemplary customer PIN mapping table used in accordance with the principles embodied in the present invention;

FIG. 6 depicts a flow diagram of a method according to an embodiment of the invention;

FIG. 7 depicts a relational diagram illustrating interaction paths between various entities within the MLM system of FIG. 1;

FIG. 8 depicts a flow diagram of a method for registration of a new selling representative in the MLM system of FIG. 1;

FIG. 9 depicts a flow diagram of a method for registration of a new customer in the MLM system of FIG. 1; and

FIG. 10 depicts a flow diagram of a method of delivery of products or services to a customer and accrual of commission to selling representatives within the MLM system of FIG. 1.

To facilitate understanding, identical reference numerals have been used, where possible, to designate identical elements that are common to the figures.

### DETAILED DESCRIPTION

The present invention will be described within the context of a multiple level enterprise, illustratively a multiple level marketing (MLM) system having a hierarchy of distributors or representatives used to sell products and/or services to customers or other distributors' representatives, and for recruiting new distributors or representatives.

Generally MLM distributors or representatives need not stockpile their own inventories and keep track of any of paperwork as most products and services are ordered by customers by directly calling toll-free telephone numbers. MLM companies usually fulfill the orders within a reasonable period of time. An alternative method of sale involves a representative receiving the stock locally from an MLM company after receiving an order from a customer, and then delivering it. However, in many MLM business plans, the commission checks for representatives are usually sent at the end of the month. A more desirable and efficient method that provides a better incentive for a representative and consequently improves sales should settle the commissions soon after the sale is over. This is provided in this disclosure through the medium of stored values as described below.

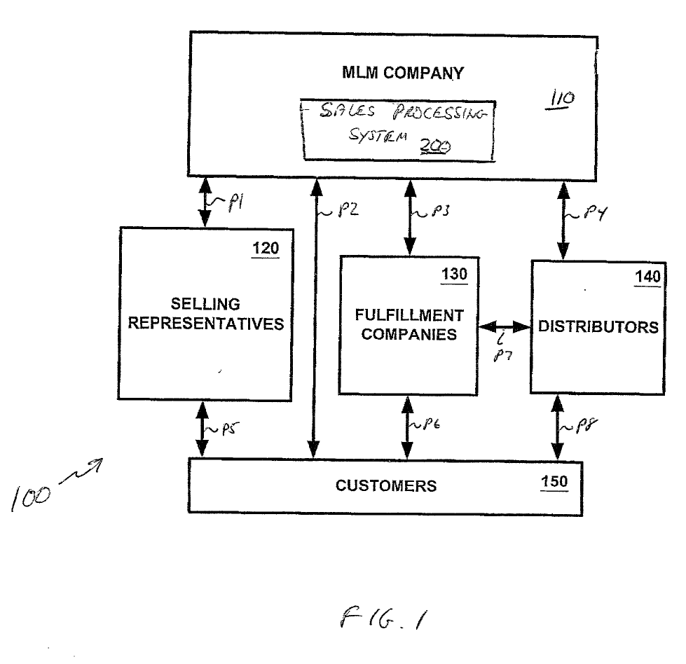

FIG. 1 is a block diagram of a multiple level marketing (MLM) system. Specifically, the MLM system 100 of FIG. 1 comprises an MLM company 110, a plurality of selling representatives 120, at least one fulfillment company 130, a plurality of distributors 140 and a plurality of customers 150.

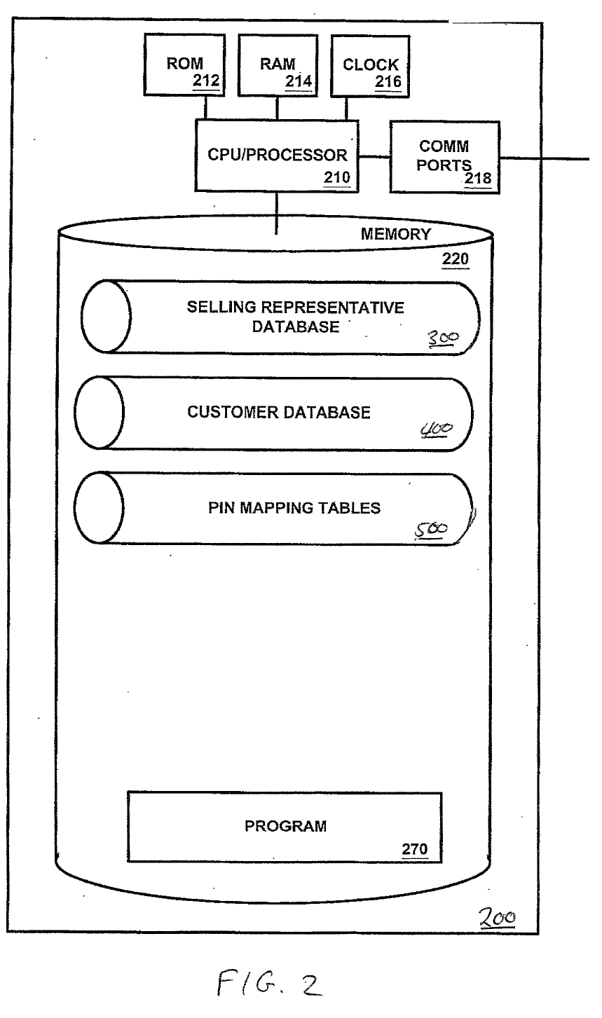

The MLM company 110 includes a sales processing system 200 which will be described in more detail below with respect to FIG. 2. The MLM company 110 manages all financial transactions among the selling representatives 120, at least one fulfillment company 130, distributors 140 and customers 150.

The selling representatives 120 comprise a plurality of selling entities related to each other in a hierarchical fashion. Each selling representative sells products and/or services to at least one customer. For each transaction (i.e., the selling of a product and/or service to a customer), a “transacting” selling representative comprises the selling representative generating the sale (i.e., the selling representative directly associated with the transacting customer). A first portion of the generated commission is payable to the transacting selling representative. “Managing” selling representatives comprise those selling representatives above the transacting selling representative within the hierarchy of selling representatives. Thus, a second portion of the commission generated by the transacting selling representative is distributed to the relevant managing selling representatives.

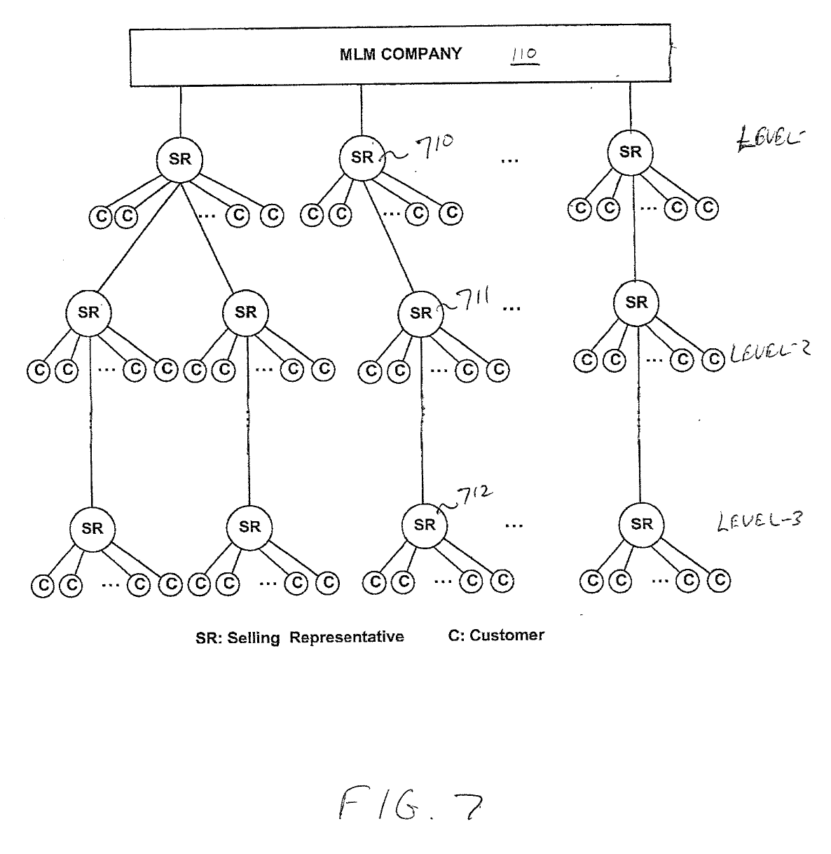

The relationships between the various selling representatives and customers are described in more detail with respect to FIG. 7. Specifically, referring to FIG. 7, an MLM company 110 is shown as being in communication with a plurality of LEVEL-1 selling representatives within an exemplary three level network. Each of the LEVEL-1 selling representatives communicates with a plurality of respective customers C. Each of the LEVEL-1 selling representatives communicates with at least one LEVEL-2 selling representative. Each of the LEVEL-2 selling representatives communicates with a respective plurality of customers. Each of the LEVEL-2 selling representatives communicates with at least one LEVEL-3 selling representative. Each of the LEVEL-3 selling representatives communicates with a respective plurality of customers. It is noted that customers may deal with a plurality of selling representatives, and that the selling representatives may occupy different levels within the hierarchy. Many levels may be used in the hierarchy. It will be noted that while a three level MLM network is shown in FIG. 7 for ease of explanation, those skilled in the art will appreciate that any number of levels may be provided within a multi-level marketing organization.

Referring to FIG. 7, if a transacting selling representative comprises SR 712 (i.e., selling representative 712 transacts with one of its respective plurality of customers), a first portion of commission generated by the transaction is payable to the transacting selling representative 712. The remaining portion of the commission paid is at least partially distributed to the respective managing selling representatives 711 and 710. The MLM company 110 optionally receives a portion of the commission to share with internal personnel and support staff as part of an incentive program.

In a preferred embodiment, each of the selling representatives SR has associated with it a stored value account. Moreover, each of the customers C also has associated with it a respective stored value account. In the case of a transaction, the value of the transaction is debited from the stored value account of the customer and remitted to a stored value account (or other account) associated with the MLM company 110. Commissions payable to the transacting and any managing selling representatives are calculated and credited to their respective stored value accounts.

In the case of transactions comprising the selling of stored value account cards to customers, the value associated with the stored value card provided to the customer is less than the value provided by the customer (e.g., as cash, credit card transfer or other value) in exchange for the stored value card. The difference in value represents the commission payable to the transacting selling representative and any managing selling representatives.

The processing of the actual sales transaction, as well as the distribution of commission allocations among transacting and managing selling representatives, is effected by the MLM company 110 using the sales processing system 200.

Referring to FIG. 1, the MLM company 110 communicates with the selling representatives 120 via path P1, the customers 150 via path P2, at least one fulfillment company 130 via path P3 and the distributors 140 via path P4. The various communication paths P1-P4 enable the MLM company 110 and, more specifically, the sales processing system 200 to receive data indicative of transactions, relationships, the flow of products and/or services and other information useful in running the enterprise. The customers 150 interact with the selling representatives 120 via path P5, the at least one fulfillment company 130 via path P6 and the distributors 140 via path P8.

With respect to the fulfillment of customer orders, upon the consummation of a transaction between a selling representative 120 and a customer 150, the at least one fulfillment company 130 is alerted by a communication received from the customer (via path P6 or, via path P2 and P3 to effect a direct customer contact with the MLM company 110) or from the selling representative via the ML company (via paths P1 and P3). In response, the fulfillment company 130 communicates with the MLM company 110 to determine whether the customer is authorized to purchase or receive the products and/or services. If authorized, then a fulfillment company 130 communicates with a distributor 140 of the products and/or services via path P7. The appropriate distributor 140 provides the purchased goods and/or services to the customers 150 via path P8.

In the preferred embodiment, transactions between customers and selling representatives (e.g., transacting selling representatives and managing selling representatives) is effected using stored value accounts, which can be accessed via the internet, the public switched telephone network (PSTN), proprietary computer networks and other known means (e.g., prepaid phone calling systems).

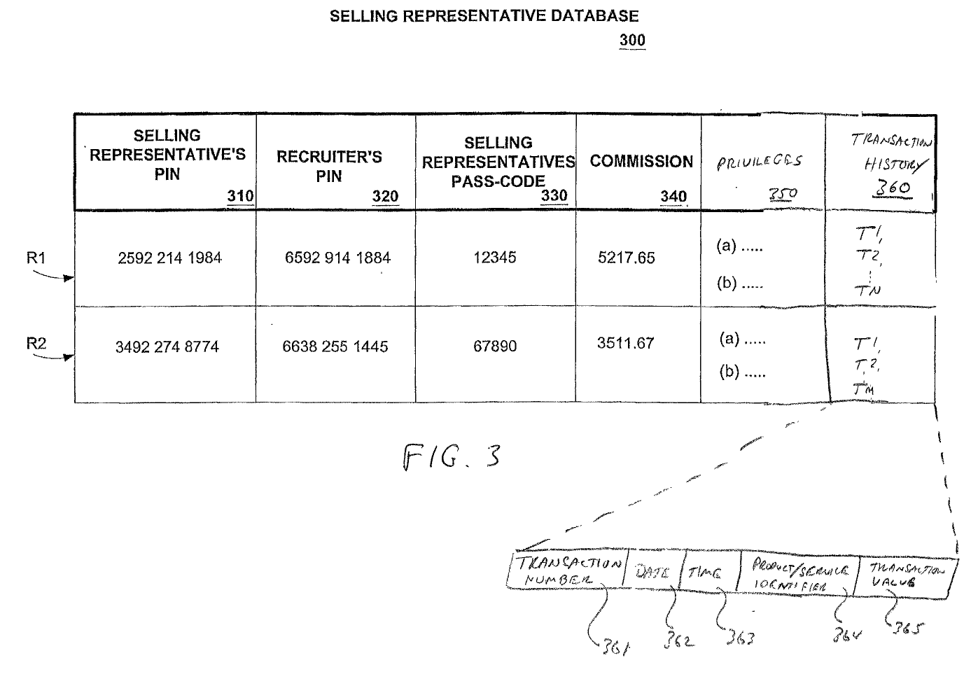

In each transaction, several personal identification numbers (PINs) are used. A transacting selling representative's PIN identifies the selling representative at any intermediate level within the network of selling representatives 120. The selling representative's PIN is used to access data associated with the selling representative stored within the selling representative database within the MLM company sales processing system 200. The selling representative database comprises information about each selling representative and will be described in more detail below with respect to FIGS. 2 and 3. The PIN associated with the recruiter of the selling representative (i.e., the managing selling representative immediately above the transacting selling representative within the hierarchy of selling representatives) is also recorded in the database to provide links within the MLM system hierarchy for at least the purpose of computing and updating commission values.

It is noted that commissions generated from customer transactions are allocated among the transacting selling representative and one or more managing selling representatives. A pass-code known to and modifiable by only the selling representative is used to provide secure access to stored commission values of the representative. Additionally, each selling representative has associated with it a set of privileges comprising, for example, indication of an ability to sell specific products and/or services (or sets of products and/or services), indication of an ability to recruit other selling representatives, indication of geographic regions within which the selling representative may operate, indication of sales or recruiting commission and/or bonuses and other incentives (generally, those other privileges useful in incentivizing the selling representative to operate his or her business).

FIG. 2 is a block diagram of an exemplary embodiment of a sales processing system for use in the MLM system of FIG. 1. The sales processing system 200 preferably includes certain standard hardware components, such as a Central Processing Unit (CPU) 210, a data storage device 220, a read-only memory (ROM) 212, a random access memory (RAM) 214, a clock 216 and a communications port 218. The CPU 210 is preferably linked to each of the other listed elements, either by means of a shared data bus, or dedicated connections, as shown in FIG. 2. The CPU 210 may be embodied as a single processor, or a number of processors operating in conjunction with one another.

The data storage device 220 and/or a ROM 212 are operable to store one or more instructions, which the CPU 210 is operable to retrieve, interpret and execute. The CPU 210 preferably includes a control unit, an Arithmetic Logic Unit (ALU) and a CPU local memory storage device, such as, for example, a stackable cache or a plurality of registers, in a known manner. The control unit is operable to retrieve instructions from the data storage device 220 of ROM 212. The ALU is operable to perform a plurality of operations needed to carry out instructions. The CPU local memory storage device is operable to provide high speed storage used for storing temporary results and control information.

The data storage device 220 typically includes one or more machine readable media; such media includes, as is well known in the art, magnetic, semi-conductor and/or optical media. Data storage device 220 is preferably capable of supporting the searching and storing of data. Data storage device 220, or portions thereof, may reside on a single computer or server, or may be distributed in a known manner among a plurality of computers or servers.

The data storage device 220 preferably includes a selling representative database 300, a customer database 400, PIN mapping tables 500 as well as other applications code and programs 270 resident at the data storage device 220. The selling representative database 300 preferably includes selling representative specific data pertaining to location and the selling representative hierarchy, identification of the recruiting selling representative, account access data, account data, privileges data, and other related information. The customer database 400 preferably includes customer specific data pertaining to customer identification, related selling representative identification, stored value levels, privileges and other related information. The PIN mapping tables 500 preferably include data relating selling representative PIN reference numbers to selling representative PIN numbers, and data relating customer PIN reference numbers to customer PIN numbers. The communications port 218 connects the controller system 200 to other MLM company systems (not shown) and/or the various entities deposited in FIG. 1.

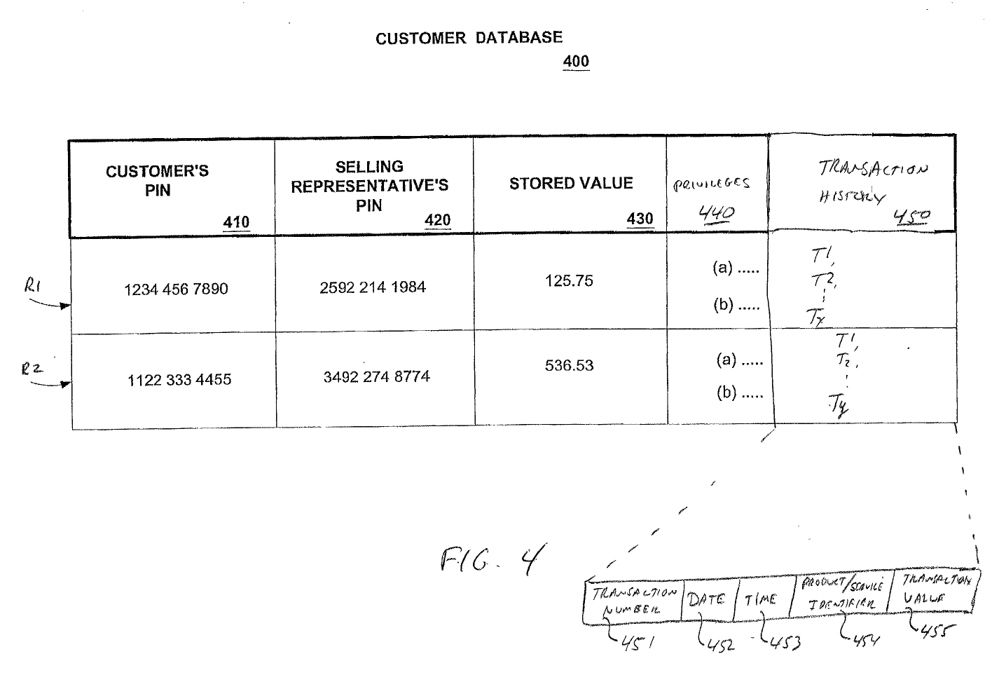

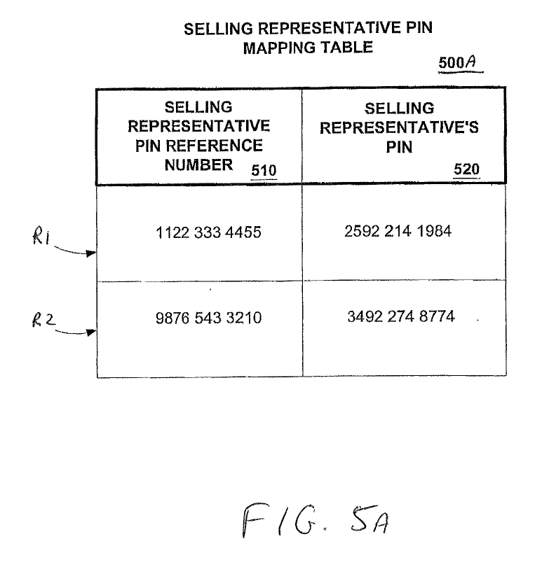

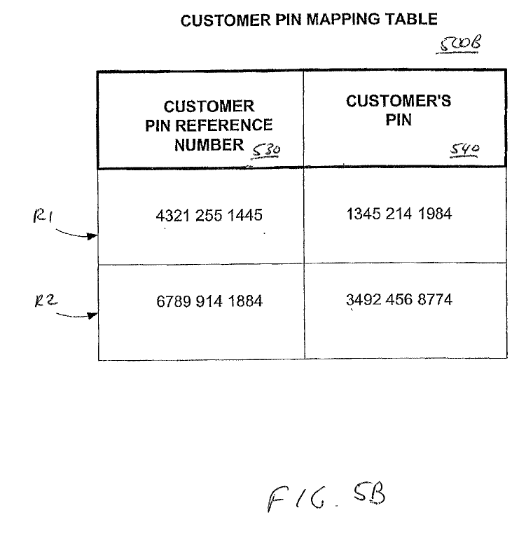

FIG. 3 is a representation of an exemplary selling representative database used in accordance with the principles embodied in the present invention. It is understood that the various rows and columns illustrated as comprising the databases in this figure represent records and fields, respectively. Thus, in each of the various described embodiments, the databases are used in a relational arrangement, as is known in the art, so that the databases relate to one another by way of fields that store common pertinent data. It is noted that while the following description refers to specific individual databases, formats, records and fields, those skilled in the art will readily appreciate that various modifications and substitutions may be made thereto without departing from the spirit and scope of the present invention. It is noted that the above understanding is also applicable to the below description of the customer database 400 of FIG. 4 and the PIN mapping tables 500A, 500B of FIG. 5.

The selling representative database 300 stores data relating to individual selling representatives within the selling representative hierarchy 120 of the MLM system 100 of FIG. 1. Each record (or row) of the selling representative database 300 is maintained for a single selling representative. By way of example, two selling representative records (R1 and R2) are shown in FIG. 3; each selling representative being identified by a personal identification number (PIN). Each record comprises a plurality of fields.

Field 310 is a selling representative's personal identification number (PIN) field, used to store an identification number corresponding to the individual selling representative. Field 320 is a recruiter's identifier field, used to store a PIN corresponding to the managing selling representative or other entity that recruited into the MLM system 100 the selling representative identified in field 310. Field 330 is a selling representative pass-code field, used to store a pass-code associated with the selling representative identified in field 310. The pass-code comprises code known to and modifiable by only the selling representative identified in field 310. The pass code enables the selling representative to securely access stored commission value identified in field 340.

Field 340 is a commission field, used to store the total value of commissions earned by the selling representative identified in field 310, or the present value of a stored value account associated with the selling representative. Field 350 is a privileges field, used to store data indicative of the various privileges associated with the selling representative identified in field 310. Such privileges include, for example, the capability of a selling representative to sell certain sets or groups of products, the capability of the selling representative to recruit other selling representatives, a geographic region within which the selling representative is to operate, any incentive or bonus programs associated with the activities of the selling representative, and other privileges useful in incentivizing the selling representative or guiding the activities of the selling representative.

Field 360 is a transactions history field, used to store information indicative of the parameters of previous transactions effected via the selling representative. For each transaction effected by the selling representative, a corresponding transaction number 361, date of transaction 362, time of transaction 363, product/service identifier 364 (i.e., the transacted for product or service), and transaction value 365 are stored. It is noted that additional transaction related parameters may be stored in the transactions history field 360. It will be appreciated by those skilled in the art that, due to memory constraints and other considerations, the transactions history field 360 may be periodically purged and/or archived.

FIG. 4 is a representation of exemplary customer database used in accordance with the principles embodied in the present invention. The customer database 400 stores data relating to accounts that are maintained for customers. Each record (or row) of the customer database 400 is maintained for one such customer. By way of example, two customer account records (R1 and R2) are shown in FIG. 4. Each record comprises a plurality of fields.

Field 410 is a customer identifier field, used to store a personal identification number (PIN) corresponding to a particular customer. Field 420 is a selling representative identifier field, used to store a PIN corresponding to the selling representative transacting with the customer identified in field 410. Field 430 is a stored value field, used to identify the stored value associated with a customer stored value account. A customer PIN is associated with a set of privileges. Field 440 is a privileges identifier field, used to identify those privileges associated with the customer identified in field 410. Such privileges include, for example, the use or limitations of use for products and/or services, any incentives associated with the customer or the products and/or services and other privileges useful in incentivizing the customer. For instance, a customer's PIN may be entitled for buying a restricted class of products or services (e.g., a PIN entitled to order video movies cannot be used for buying goods). Field 450 is a transaction history field, used to store information indicative of the parameters of previous transactions effected via the selling representative. For each selling representative transaction, a corresponding transaction number 451, date of transaction 452, time of transaction 453, product/service identifier 454 (i.e., the transacted for product or service), and transaction value 455 are stored. It is noted that additional transaction related parameters may be stored in the transactions history field 450. It is noted that additional transaction related parameters may be stored in the transaction history field 450. It will be appreciated by those skilled in the art that, due to memory constraints and other considerations, the transactions history field 450 may be periodically purged and/or archived.

FIG. 5A is a representation of an exemplary selling representative PIN mapping table used in accordance with the principles embodied in the present invention. The selling representative PIN mapping table 500A of FIG. 5A stores data relating (or mapping) a recruited selling representative's PIN reference number to a selling representative's PIN.

Field 510 is a selling representative PIN reference number field, used to store an identification number corresponding to the PIN associated with any sales representatives recruited. This PIN reference number is known also to the recruiting selling representative and may be provided on, for example, the face of a card provided to the recruited selling representative. Field 520 is a selling representative's PIN reference number field, used to identify the PIN of a particular selling representative. This PIN is known only to the recruited selling representative and may be hidden under a “scratch off” portion of the card provided to the recruited selling representative.

FIG. 5B is a representation of an exemplary customer PIN mapping table used in accordance with the principles embodied in the present invention. The customer PIN mapping table 500B of FIG. 5B stores data relating (or mapping) the customer PIN number to the PIN number of the selling representative transacting with the customer.

Field 530 is a customer representative PIN reference number field, used to store an identification number corresponding to the actual PIN associated with a new customer. The PIN reference number is known also to the recruiting selling representative and may be provided on, for example, the face of a card provided to the new customer. Field 540 is a customer PIN number field, used to identify the actual PIN of the customer. The actual PIN number is known only to the customer and may be hidden under a “scratch off” portion of the card provided to the customer.

In one embodiment, the MLM system 100 provides for the sale of prepaid stored value cards. In this business model, the MLM representatives basically sell prepaid stored value cards or PINs to customers and other representatives. A customer can then buy products and services from the MLM company by using the PIN on a prepaid card. A customer's PIN is linked to the PIN of the selling 10 representative through a Customer Database as shown in FIG. 4. Every time a customer buys a product or service using the stored value card, the stored value corresponding to PIN of the selling representative is incremented by a value corresponding to the commission or other benefits associated with the sale. Also, the MLM system automatically updates the stored values of the various other selling representatives linked in the MLM hierarchy with reference to the sale.

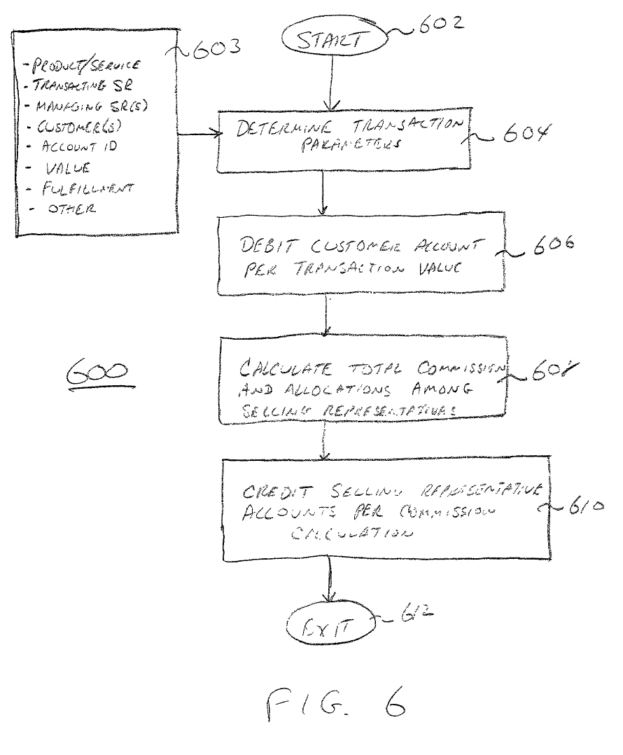

FIG. 6 depicts a flow diagram of a method according to an embodiment of the invention. Specifically, FIG. 6 depicts a flow diagram of a method 600 for automatically processing the proceeds of a transaction.

The method 600 is entered at step 602 and proceeds to step 604 where the parameters of a transaction are determined. The transaction parameters include, for example, those parameters listed in box 603; namely, the product or service procured on behalf of the customer, identification of the transacting selling representative, identification of any managing selling representatives, identification of the customer, account identification of credit card or stored value accounts associated with the customer, transacting selling representative and any managing selling representatives, the value of the transaction, fulfillment details such as delivery particulars, special requests and the like, and other parameters useful in effecting the transaction. The method 600 then proceeds to step 606.

At step 606, the customer account is debited according to the transaction value. For example, in the case of a transaction comprising the sale of a stored value account (i.e., a stored value card having associated with it a value), the stored value account is debited according to the commission owed for the transaction. The method 600 then proceeds to step 608.

At step 608, the total commission is calculated and allocations of the commission among the transacting selling representative and any managing selling representatives are determined. The method 600 then proceeds to step 610.

At step 610, the transacting and managing selling representative accounts are credited per the commission and commission allocations determined at step 606. The method 600 then exits at step 612.

With the business model described herein, at any time there can be a chain of representatives at different levels (as shown illustratively in FIG. 7). Whenever a transaction event occurs (e.g., the buying of a product or service by a customer, the selling of prepaid cards to customers or representatives and the like), its effect moves up the hierarchy in terms of incrementing of stored values associated with PINs in the relevant upward chain of selling representatives. The aggregated effect of all the transactions at lower levels is reflected at any time in the updated stored value of a representative. With this model of MLM business, all the settlements among selling representatives, customers, and the MLM Company are carried out at the time of sale itself through their respective stored values.

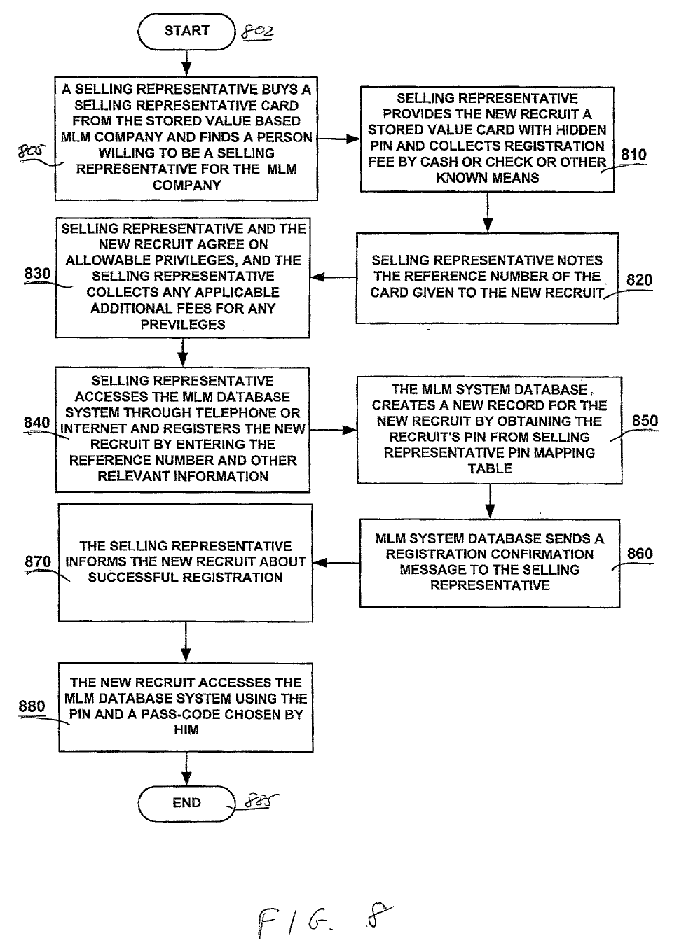

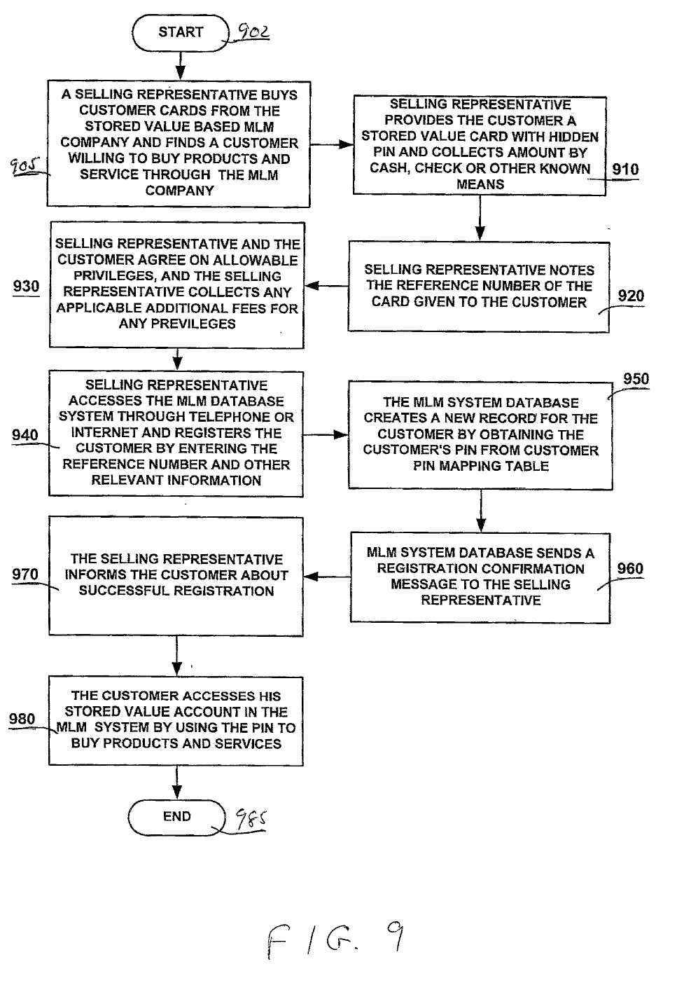

FIG. 8 and FIG. 9 depict flow diagrams of methods for, respectively, registering a new selling representative and registering a new customer in the MLM system of FIG. 1. In a preferred embodiment, a selling representative supplies PINs to new selling representative recruits or customers by means of cards on which the PINs are hidden by a “scratch off” covering. The selling representative only knows the associated reference numbers of the PINs. The new recruits or customers come to know of their PINs by scratching off the covering on the printed PINs. Alternatively, the PINs can be provided to the recruits and customers in sealed envelopes that have the associated reference numbers printed on them.

Referring now to FIG. 8, a method 800 for registration of a new selling representative in the system 100 of FIG. 1 is shown. Specifically, the method 800 is entered at step 802 and proceeds to step 805, where a selling representative buys a selling representative card from the stored value based MLM company and finds a person willing to be a selling representative for the MLM company. The method 800 then proceeds to step 810.

At step 810, the selling representative provides the new recruit with a stored value card having a hidden PIN, and collects a registration fee via cash, negotiable instruction (such as a personal check) or other means.

At step 820, the selling representative notes the reference number of the card given to the new recruit. At step 830, the selling representative and the new recruit agree on the allowed privileges. It is noted that the privileges agreed to at step 830 may include privileges requiring the payment of additional value by the customer. Thus, at step 830, in the case of the selling representative and customer agreeing on allowed privileges that require the payment of additional value, such additional value is tendered to the selling representative directly, debited from the stored value account, stored value card or other account associated with the customer and otherwise proffered to the MLM company operating the network to which the new recruit is joining. Step 830 provides an opportunity for the selling representative to “up sell” additional products or services to the new recruit. Such additional products or services may include training kits or other sales and/or recruitment aids that the new recruitment may use to increase his own business. As is known in multi-level marketing, much of the profits made by a selling representative are made by selling products or services to those selling representatives below him or her in the hierarchy. Thus, at step 830 the up sell opportunity is provided to the selling representative, while the opportunity to purchase more value added products and/or services is provided to the new recruit.

At step 840, the selling representative accesses the MLM data base system via telephone or internet (or other means) and registers the new recruit by entering the reference number and other relevant information.

At step 850, the MLM system database creates a new record for the new recruit by obtaining the recruit's PIN from the selling representative PIN mapping table. At step 860, the MLM system database sends a registration confirmation message to the selling representative. At step 870, the selling representative informs the new recruit that a successful registration has occurred. At step 880, the new recruit accesses the MLM database system using the PIN and a pass code chosen by the new recruit. The method exits at step 885.

FIG. 9 depicts a flow diagram of a method for registration of a new customer in the MLM system of FIG. 1. The method 900 of FIG. 9 is entered at step 902 and proceeds to step 905, where a selling representative buys customer cards from the stored value based MLM company and finds a customer willing to buy products and services through the MLM company.

At step 910, the selling representative provides the customer with a stored value card having a hidden PIN and collects determined value or amount via cash, negotiable instrument (such as a check) or other known means.

At step 920, the selling representative notes the reference number of the card given to the customer.

At step 930, the selling representative and the customer agree on the allowed privileges of the customer. It is noted that the privileges agreed to at step 930 may include privileges requiring the payment of additional value by the customer. Thus, at step 930, in the case of the selling representative and customer agreeing on allowed privileges that require the payment of additional value, such additional value is tendered to the selling representative directly, debited from the stored value account, stored value card or other account associated with the customer and otherwise proffered to the MLM company operating the network to which the customer is joining. Step 930 provides an opportunity for the selling representative to “up sell” additional products or services to the customer. Such additional products or services may include training kits, sales and/or customer aids, and the like. As is known in multi-level marketing, much of the profits made by a selling representative are made by selling products or services to those selling representatives below him or her in the hierarchy. Thus, at step 930 the up sell opportunity is provided to the selling representative, while the opportunity to purchase more value added products and/or services is provided to the customer.

At step 940, the selling representative accesses the MLM database system via telephone, internet or other means and registers the customer by entering the reference number and other relevant information.

At step 950, the MLM system database creates a new record for the customer by obtaining the customer's PIN from the customer PIN mapping table.

At step 960, the MLM system database sends a registration confirmation message to the selling representative.

At step 970, the selling representative informs the customer that a successful registration has occurred.

At step 980, the customer accesses his stored value account in the MLM system by using the PIN to buy products and/or services. The method 900 exits at step 985.

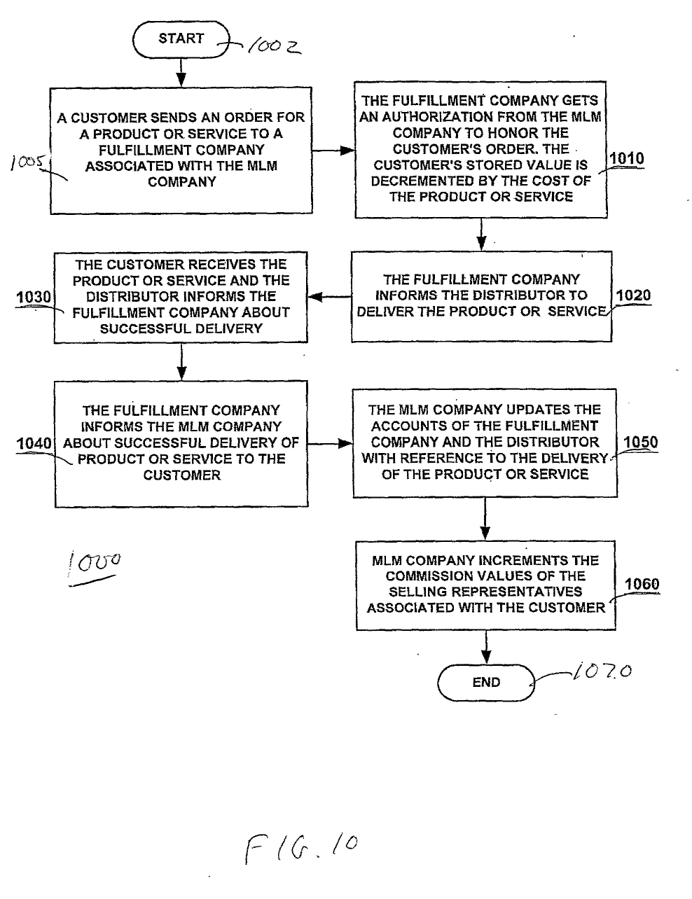

FIG. 10 depicts a flow diagram of a method of delivery of products or services to a customer and accrual of commission to selling representatives within the MLM system 100 of FIG. 1.

The method 1000 of FIG. 10 is entered at step 1002 and proceeds to step 1005, when a customer sends an order for a product or service to a fulfillment company 130 associated with the MLM company. The fulfillment company receives an authorization from the MLM company to honor the customer's order. The customer's stored value is then decremented by the cost of the product or service ordered. It is noted that the authorization received by the fulfillment company may be in response to a communication from the fulfillment company, in response to a communication made by the customer to the MLM company contemporaneous with the order placed with the fulfillment company, or an authorization received in response to other stimulus.

In one embodiment of the invention, the customer places an order directly with the MLM company. By working directly with the MLM company, the customer may additionally provide information regarding the product and/or service desired and may express a preference as the fulfillment company to be used. For example, the customer may indicate a preferred fulfillment company or a non-preferred fulfillment company. Such preferred or non-preferred status of fulfillment companies is entirely subjective to the customer, and may be based upon prior transactions or the reputation of various fulfillment companies. The MLM company then communicates with the preferred fulfillment company to provide the desired product and/or service. In this manner, the PIN number associated with a customer may be provided to fewer fulfillment companies, thereby enhancing the security of such PIN numbers. For example, a disfavored fulfillment company may be one that the customer deems untrustworthy with respect to the customer PIN number.

At step 1020, the fulfillment company informs the distributor to deliver the product or service to the ordering customer.

At step 1030, the customer receives the product or service, and the distributor informs the fulfillment company that a successful delivery has occurred.

At step 1040, the fulfillment company informs the MLM company that the successful delivery of the product or service to the customer has occurred.

At step 1050, the MLM company updates the accounts of the fulfillment company and the distributor with reference to the delivery of the product or service.

At step 1060, the MLM company increments the commission values of the selling representatives associated with the customer. That is, at step 1060, the commission field 340 of the transacting selling representative and any managing selling representative is increased by the appropriate portion of commission generated by the transaction. The method 1000 exits at step 1070.

In the event a customer returns a product, a similar process of updating the stored values occurs as per pre-defined rules.

It will be appreciated by those skilled in the art that the above-described steps forming the respective methods of FIGS. 6, 8, 9 and 10 may be performed in a different order, or may be performed simultaneously.

Although various embodiments which incorporate the teachings of the present invention have been shown and described in detail herein, those skilled in the art can readily devise many other varied embodiments that still incorporate these teachings. sales or recruiting commission structure and a sales or recruiting bonus structure:

5. The method of claim 1, further comprising:
creating, in a database, a record for said purchaser including said stored value card reference number, a PIN associated with said purchaser and a PIN associated with a recruiting representative, said recruiting representative providing said stored value card to said purchaser.

6. The method of claim 5, further comprising:
providing a confirmation of registration message to said recruiting representative and said purchaser, said confirmation message indicating that said purchaser may access the database.

7. The method of claim 6, further comprising:
receiving, from said purchaser, a pass code for subsequent use in accessing value associated with said first stored value account.

8. A method for use in a multiple level marketing (MLM) system comprising a plurality of selling representatives financially cooperating in a hierarchical manner, said method comprising:
providing, to a new selling representative in exchange for a first value, a stored value card having associated with it a stored value account of an initial value, a reference number and a first personal identification number (PIN);
registering said new selling representative within said MLM system using said stored value card reference number; and crediting, to respective stored value accounts of selling representatives hierarchically superior to said new selling representative, respective apportioned commissions earned by the use of said stored value card, said stored value card account value being debited in response to said use and said credited commissions.

9. The method of claim 8, further comprising:
defining a set of privileges for said new selling representative; and
crediting, to respective stored value accounts of selling representatives hierarchically superior to said new selling representative, respective apportioned fees earned according to said defined set of privileges.

10. The method of claim 9, wherein said privileges comprise at least one of an ability to sell specific products or services, an ability to recruit other selling representatives, an ability to operate within a particular geographic region, a sales or recruiting commission structure and a sales or recruiting bonus structure.

11. The method of claim 8, wherein said registering comprises: providing, to an MLM system database, said stored value card reference number and data regarding said new selling representative.

12. The method of claim 8, further comprising:
creating, in an MLM system database, a record for said new selling representative including said stored value card reference number, a PIN associated with said new selling representative and a PIN associated with a recruiting selling representative, said recruiting selling representative providing said stored value card to said new selling representative.

13. The method of claim 12, further comprising:
providing a confirmation of registration message to said recruiting selling representative and said new selling representative, said confirmation message indicating that said new selling representative may access the MLM system database.

14. The method of claim 13, further comprising:
receiving, from said new selling representative, a pass code for subsequent use in accessing value associated with said stored value card.

15. A data structure, comprising:
a plurality of stored value accounts, each of said stored value accounts having associated with it a value parameter indicative of a present stored value, a personal identification number (PIN) indicative of an account owner logically linked to a stored value account of a selling representative; wherein the value parameter of a stored value account used to effect a purchase is debited according to the value of said purchase; and
in the case of said purchase generating a commission, the value parameter of a logically linked stored value account is credited according to the value of said commission.
